(19) United States
(12) Patent Application Publication
(10) Pub. No.: US 2004/0159243 A1
(43) Pub. Date: Aug. 19, 2004

(54) Fryer system with floating check valve for vacuum release on oil manifolds

(75) Inventor: Michael Andrew Theodos, Bossier City, LA (US)

Correspondence Address: Paul D. Greeley, Esq., Ohlandt, Greeley, Ruggiero & Perle, L.L.P., 10th Floor, One Landmark Square, Stamford, CT, 06901-2682, US

(73) Assignee: The Frymaster Corporation

(21) Appl. No.: 10/366,642

(22) Filed: Feb. 13, 2003

(51) Int. Cl. A47J 37/12

(52) U.S. Cl. 99/330; 99/403

(57) ABSTRACT

A fryer system and a check valve useful in the fryer system or in other applications. The check valve does not require electricity or springs, but rather operates based on fluid flow and/or pressure. The check valve includes a sealing member that is disposed in a chamber. The chamber is in fluid communication with ambient air and a fluid container, such as a rear return manifold in the fryer system. As fluid, such as cooking oil, is supplied to the manifold, the cooking oil rises in the chamber of the floating check valve. The sealing member floats on the rising cooking oil until it seats in a seal so as to close the fluid communication with ambient. When the cooking oil is drained from the manifold, the sealing member disengages from the seal and floats in the chamber to a retainer that allows ambient air to pass through the fluid communications and chamber to counteract any vacuum in the ullage of the manifold.

### FIELD OF THE INVENTION

This invention relates to a fryer system having a check valve that provides a vacuum release to a manifold during drainage of cooking oil from the manifold. The check valve may also be useful in other applications.

### BACKGROUND OF THE INVENTION

A fryer system typically has a rear manifold that distributes filtered cooking oil to one or more fryers in a filtration mode. When the fryers have been filled with cooking oil, cooking oil remaining in the rear manifold is drained or transferred to a drain pan. A vacuum is created when the cooking oil drains without air being admitted to back-fill the removed cooking oil. This vacuum has been broken in the past with the use of solenoid valves. The solenoid valve is closed when oil is being distributed to the fryers. When the fryers have been filled, draining begins and the solenoid valve is opened to allow air into the manifold. A disadvantage of this technique is that the cooking oil, still being under pressure, back flows so as to bypass the solenoid valve when it is opened, thereby requiring a separate drainage for the bypass cooking oil.

Accordingly, there is a need for a valve that eliminates the backflow of cooking oil and the requirement for a separate drainage for the bypass oil.

### SUMMARY OF THE INVENTION

A fryer system of the present invention comprises one or more fryers that heat cooking oil to fry food products, a manifold that distributes cooking oil to the fryers and a floating check valve. The floating check valve comprises a chamber in fluid communication with a first orifice and a second orifice, wherein the second orifice is in fluid communication with the manifold and the first orifice is in fluid communication with ambient air. A seat is connected to the first orifice. A sealing member is disposed in the chamber and responds to cooking oil admitted via the second orifice to float in the chamber into engagement with the seat. When cooking oil is drained from the manifold and the chamber, the sealing member releases from the seat, thereby admitting air from ambient to the manifold.

The seat is preferably a seal, such as a gasket.

In another embodiment of the present invention, the release from the seat is caused by a vacuum in the chamber formed by the draining liquid. The pressure of the vacuum overcomes the pressure of air admitted via the first orifice, thereby causing the release of the buoyant member.

In another embodiment of the present invention, the check valve further comprises a first channel and a second channel connected to the first orifice and the second orifice, respectively.

In an alternate embodiment, the check valve comprises a body in which the first and second channels comprise first and second bores therein.

The sealing member may be at least partially hollow and is preferably selected from the group consisting of: a ball, a disk, a cylinder and a cone.

The fryer system of the present invention is particularly advantageous as it has no oil backflow and does not rely on electricity or springs for operation, but rather operates based on fluid flow and/or pressure.

The check valve of the present invention comprises a chamber that is in fluid communication with first and second orifices. A sealing member responds to liquid admitted via the second orifice to float in the chamber into engagement with a seat that is connected to the first orifice. When the liquid drains from the chamber, the sealing member releases from the seat, thereby providing an open fluid communication between the first and second orifices via the chamber.

The check valve of the present invention is particularly advantageous as it has no oil backflow and does not rely on electricity or springs for operation, but rather operates based on fluid flow and/or pressure.

### BRIEF DESCRIPTION OF THE DRAWINGS

Other and further objects, advantages and features of the present invention will be understood by reference to the following specification in conjunction with the accompanying drawings, in which like reference characters denote like elements of structure and:

FIG. 1 is a block diagram of a fryer system according to the present invention;

FIG. 2 is a view in elevation of the floating check valve of the FIG. 1 fryer system in an open position;

FIG. 3 is a cross-sectional view taken along line 3-3 of FIG. 2;

FIG. 4 is a view in elevation of the floating check valve of the FIG. 1 fryer system in a closed position; and

FIG. 5 is a cross-sectional view taken along line 5-5 of FIG. 4.

### DESCRIPTION OF THE PREFERRED EMBODIMENT

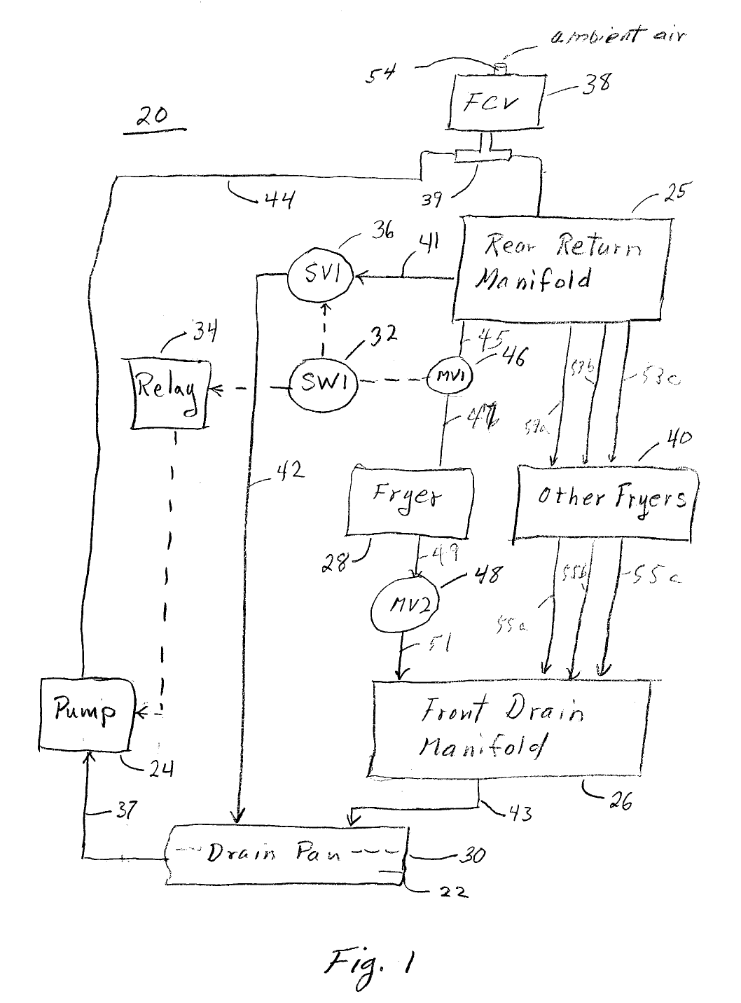

Referring to FIG. 1, a frying system 20 includes a fryer 28, a drain pan 30, a pump 24, a floating check valve 38, a rear return manifold 25 and a front drain manifold 26. In FIG. 1, fluid connections are represented with solid lines and electrical connections are represented by dashed lines.

Pump 24 is connected to drain pan 30 via a fluid line or conduit 37 and to rear manifold 25 via a conduit 44. Floating check valve 38 is disposed in conduit 44. Floating check valve 38 has an orifice 54 that is in fluid communication with ambient air (e.g., air at atmospheric pressure). A conduit 45 connects rear manifold 25 to a manual valve 46, which in turn is connected to fryer 28 via a conduit 47. A conduit 41 connects rear manifold 25 to a solenoid valve 36, which in turn is connected to drain pan 30 via a conduit 42. A conduit 49 connects fryer 28 to a manual valve 48, which in turn is connected to front drain manifold 26 via a conduit 51. A conduit 43 connects front drain manifold 26 to drain pan 43.

During a fryer filtration mode, manual valve 46 is opened and manual valve 48 is closed. Manual valve 46 is coupled to a switch 32 such that the opening and closing of manual valve 46 closes and opens switch 32, respectively. When closed, switch 32 activates a relay 34 that turns pump 24 on and closes solenoid valve 36. Pump 24 is then operative to pump cooking oil 22 from drain pan 30 to fryer 28 via conduits 37 and 44, rear return manifold 25, conduit 45, manual valve 46 and conduit 47. Cooking oil 22 is passed through a filter (not shown) located in the bottom of drain pan 30. For example, the filter may be comprised of a filter paper held down by a metal ring.

In accordance with the present invention, floating check valve 38 is disposed in conduit 44 between pump 24 and rear return manifold 25 so as to be in fluid communication with rear return manifold 25 and with ambient air or other source of air having a positive pressure via orifice 54. Floating check valve 38 is connected to conduit 44 via a T connector 39. Floating check valve 38 is disposed in a vertical position by T connector 39. Preferably, floating check valve 38 is located at the highest point of system 20. During the filtration mode, floating check valve 38 is closed so that no air is admitted to rear manifold 25, while cooking oil 22 is being pumped to fryer 28 from drain pan 30 via conduit 37, pump 24, conduit 44, rear return manifold 25, conduit 45, manual valve 46 and conduit 47.

When fryer 28 has been filled, manual valve 46 is closed, thereby opening switch 32. The opening of switch 32 deactivates relay 34, thereby shutting off pump 24 and de-energizing solenoid valve 36. This causes solenoid valve 36 to open, thereby allowing cooking oil 22 to flow out of rear return manifold 25 to drain pan 30 via conduit 41, solenoid valve 36 and conduit 42. Floating check valve 38 opens to admit air via orifice 54 and conduit 44 into manifold 25 to counteract any vacuum caused in rear manifold 25 by the flow of cooking oil to drain pan 30.

Manual valve 48 is opened when it is desired to drain cooking oil 22 from fryer 28. Cooking oil 22 then flows out of fryer 28 to drain pan 30 via conduit 49, manual valve 48, conduit 51, front drain manifold 26 and conduit 43.

Rear return manifold 25 and front drain manifold 26 may also be connected to distribute cooking oil 22 via one or more conduits 53a, 53b and 53c to other fryers 40. Other fryers 40 are in turn connected to front drain manifold 26 via conduits 55a, 55b and 55c.

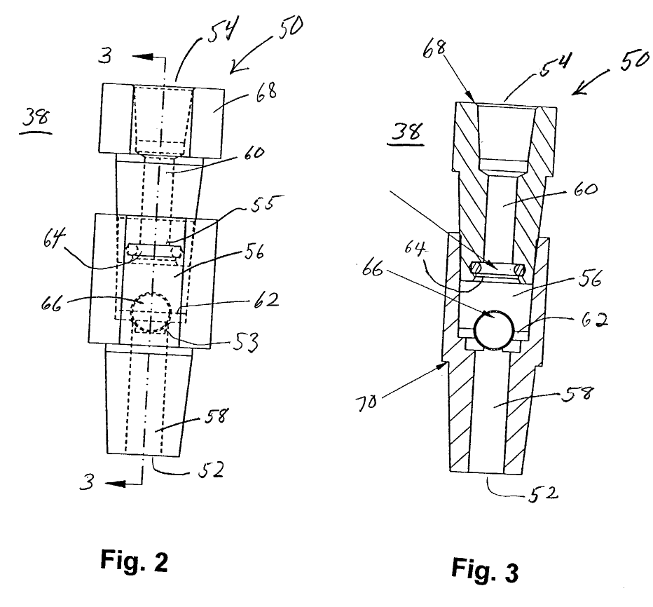

Referring to FIGS. 2 and 3, floating check valve 38 has a body 50 that comprises a chamber 56, a channel 58 and a channel 60. Channel 58 has an orifice 52 disposed at one end thereof and an orifice 53 disposed at an opposite end thereof. Orifice 52 is adapted to be connected in fluid communication with a liquid system. Channel 60 has an orifice 54 disposed at one end thereof and an orifice 55 disposed at an opposite end thereof. Orifices 53 and 55 are disposed to adjacent opposite sides of and in fluid communication with chamber 56. Orifice 54 is adapted for fluid communication with a source of air, such as ambient air. On the other hand, orifice 52 is adapted for fluid communication with a liquid system. Thus, in fryer system 20, orifice 52 is connected via Tee 39 to conduit 44 and orifice 54 is connected to ambient air.

A retainer 62 is disposed in registry with orifice 53 and a seat 64 is disposed in registry with orifice 55. A sealing member 66 is disposed in chamber 56 for engagement with seat 64 when floating check valve 38 is closed and out of engagement with seat 64 when open.

Sealing member 66 may have any suitable shape that permits buoyancy. For example, sealing member 66 may be a ball, a disk, a cylinder, a cone or other suitable shape that allows sealing member 66 to float on cooking oil 22. For example, sealing member 66 may be hollow. Sealing member 66 may be constructed of any suitable material, such as plastic or metal.

Retainer 62 has one or more bypass passages (not shown) that allow air admitted via orifice 54 and chamber 56 to flow through the bypass passages and orifice 52 to rear return manifold 25. For example, retainer 62 may have a slot that has a length longer than its width. Sealing member 66 rests on top of the slot, thereby creating two rectangular cross-sectional bypass passages in retainer 62 at 180° on either end of sealing member 66. Air is able to flow from chamber 56 through the bypass passages and/or under sealing member 66 and exit retainer 62 via orifice 52.

Seat 64 may be any suitable material for forming a seal when sealing member 66 is seated therein. For example, seat 64 may be an O-ring that is fitted in an annular groove of orifice 55.

Channels 56 and 58 may have any suitable shape. Preferably, channels 56 and 58 are bores in body 50. Body 50 may be formed of two separate pieces to allow sealing member 66 to be placed in chamber 56 during assembly. To this end, body 50 is shown as having a top float member 68 and a bottom float member 70 that fit together in a telescopic manner. Top float member 68 and bottom float member 70 may be fastened to one another by a force fit, screw threads, a key, bolts or by any other fastener known currently or in the future. It will be apparent to those skilled in the art that body 50 may be formed from an alternative set of separate pieces. For example, body 50 may be formed as two pieces that fit together in a clam shell fashion.

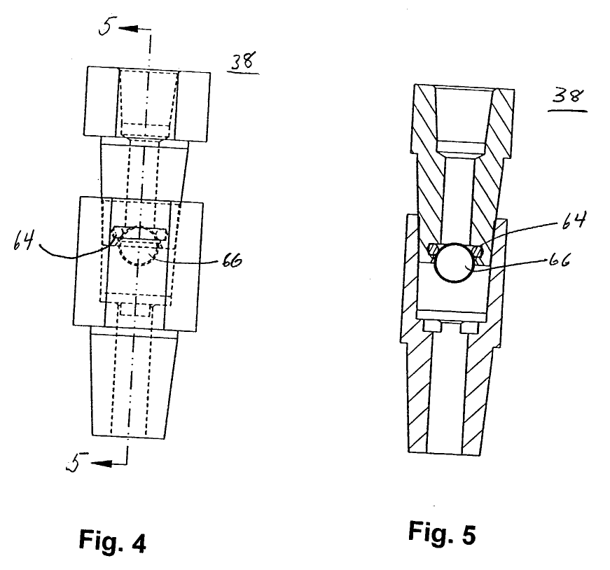

As the filtration mode begins, sealing member 66 is engaged with retainer 62. For example, sealing member 66 may be in contact with retainer 62 as shown in FIGS. 2 and 3. Opening manual valve 46 closes switch 32, which activates relay 34 so as to turn pump 24 on. Switch 32 also activates solenoid valve 36. Manual valve 48 is closed during the filtration mode. Cooking oil 22 is pumped by pump 24 into rear return manifold 25 via fluid line 44. Cooking oil 22 flowing in fluid line 44 enters orifice 52 of floating check valve 38 and rises through the bypass passages of retainer 62 into chamber 56. As cooking oil 22 continues to rise, sealing member 66 floats on the surface thereof in chamber 56. Chamber 56 and/or seat 64 are shaped so that sealing member 66 is guided into seat 64 and is retained therein by the pressure of the cooking oil. This position is shown in FIGS. 4 and 5. When sealing member 66 is in this position, floating check valve 38 is closed.

When manual valve 46 is closed, switch 32 de-energizes relay 34 and solenoid valve 36. This turns pump 24 off. The level of cooking oil 22 descends in rear return manifold 25 and in chamber 56 of floating check valve 38. Sealing member 66 may or may not immediately release from seat 64. If sealing member 66 does immediately release as the cooking oil level falls, sealing member 66 will float on the cooking oil surface and come to rest on retainer 62 when the level falls below chamber 56. On the other hand, sealing member 66 may stick in seat 64 as the cooking oil level falls. The drainage of cooking oil 22 from rear return manifold 25 causes a vacuum or low pressure in the ullage of manifold 25. This low pressure provides suction that releases sealing member 66 from seat 64. In either case, floating check valve 38 opens upon release of sealing member 66 from seat 64. When floating check valve 38 is open, air is admitted into chamber 56 and into rear return manifold 25 via retainer 62. This flow of air from ambient counteracts the vacuum in the ullage of rear return manifold 25, thereby providing an efficient drainage of cooking oil 22.

Floating check valve 38 has the advantages of being springless, as well as being operable without the use of electricity. Also, floating check valve 38 does not result in an overflow of cooking oil 22 upon opening since it does not release until the pressure relieves.

Floating check valve 38 can be used at any pressure for either gas or liquid. For example, when using vegetable oil, the pressure is preferably below 10 psig. Depending upon the pressure being observed, seat 64 and its enclosure are designed accordingly.

The present invention having been thus described with particular reference to the preferred forms thereof, it will be obvious that various changes and modifications may be made therein without departing from the spirit and scope of the present invention as defined in the appended claims.

What is claimed is:

1. A fryer system comprising:
at least one fryer that heats cooking oil to cook food products;
a manifold that distributes said cooking oil to said fryer; and
a valve comprising:
a chamber in fluid communication with a first orifice and a second orifice, wherein said second orifice is in fluid communication with said manifold and said first orifice is in fluid communication with ambient air;
a seat connected to said first orifice; and
a sealing member disposed within said chamber and, optionally, in contact with said seat.

2. The fryer system of claim 1, wherein said sealing member is capable of forming a liquid tight seal with said seat.

3. The fryer system of claim 1, wherein said seat comprises a seal.

4. The fryer system of claim 1, wherein said valve is springless.

5. The fryer system of claim 1, further comprising a first channel and a second channel connected to said first orifice and second orifice, respectively.

6. The fryer system of claim 5, further comprising a body, and wherein said first and second channels comprise first and second bores in said body, respectively.

7. The fryer system of claim 1, wherein said sealing member is selected from the group consisting of: ball, disk, cylinder and cone.

8. The fryer system of claim 1, wherein said sealing member is at least partially hollow.

9. A check valve comprising:
a chamber in fluid communication with a first orifice and a second orifice;
a seat connected to said first orifice; and
a sealing member disposed within said chamber and, optionally, in contact with said seat.

10. The check valve of claim 9, wherein said sealing member is capable of forming a liquid tight seal with said seat.

11. The check valve of claim 9, wherein said seat comprises a seal.

12. The check valve of claim 9, wherein said check valve is springless.

13. The check valve of claim 9, further comprising a first channel and a second channel connected to said first orifice and said second orifice, respectively.

14. The check valve of claim 13, further comprising a body, and wherein said first and second channels comprise first and second bores in said body, respectively.

15. The check valve of claim 9, wherein said sealing member is selected from the group consisting of: ball, disk, cylinder and cone.

16. The check valve of claim 9, wherein said sealing member is at least partially hollow.
